(19) United States
(12) Patent Application Publication
(10) Pub. No.: US 2021/0323413 A1
(43) Pub. Date: Oct. 21, 2021

(54) SYSTEM FOR ESTIMATING BRAKE DAMAGE LEVEL OF VEHICLE AND METHOD OF CONTROLLING THE SAME

(71) Applicants: HYUNDAI MOTOR COMPANY, Seoul (KR); KIA MOTORS CORPORATION, Seoul (KR)

(72) Inventor: Yong Gu Kang, Suwon-si (KR)

(21) Appl. No.: 16/952,610

(22) Filed: Nov. 19, 2020

(30) Foreign Application Priority Data
Apr. 17, 2020 (KR) 10-2020-0046547

(51) Int. Cl. B60L 7/26; B60T 8/171; B60T 8/172; B60T 8/17; B60T 17/22

(52) U.S. Cl. CPC B60L 7/26; B60T 8/171; B60T 8/172; B60T 13/586; B60T 17/221; B60T 2270/604; B60T 8/17

(57) ABSTRACT

The vehicle of the disclosure includes: a brake; an vehicle sensor configured to obtain external environment information of the vehicle; a brake damage calculator configured to estimate a damage level of the brake based on the external environment information; a braking ratio calculator configured to calculate a regenerative braking and hydraulic braking performance ratio of the vehicle based on the estimated damage level of the brake; and a controller configured to control the vehicle to perform regenerative braking and hydraulic braking according to the calculated regenerative braking and hydraulic braking performance ratio.

### CROSS-REFERENCE TO RELATED APPLICATION(S)

This application is based on and claims priority to Korean Patent Application No. 10-2020-0046547, filed on Apr. 17, 2020 in the Korean Intellectual Property Office, the disclosure of which is incorporated by reference in its entirety.

### TECHNICAL FIELD

The present disclosure relates to a vehicle and a method of controlling the vehicle.

### BACKGROUND

When a vehicle has been parked overnight, noise may be generated during initial braking due to the presence of moisture in brake pads, generating a moisture state, and rusting a brake disc. In order to solve this problem, a conventional internal combustion engine vehicle is generally subjected to a large level of hydraulic braking, so that moisture and corrosion of brake pads and disc may be removed in a short time. However, in eco-friendly vehicles such as Electronic Vehicle/Hybrid Electronic Vehicle (EV/HEV) that perform regenerative braking, since the amount of hydraulic braking is reduced according to an operation of the regenerative braking, hydraulic braking is powerful, so it takes a long time to remove the moisture and corrosion, and noise due to a friction surface continues to occur.

In order to effectively perform hydraulic braking of eco-friendly vehicles such as the EV/HEV that performs regenerative braking, a method of estimating an idle time after parking of the vehicle using current time information, estimating the amount of moisture and corrosion of the brake using this, and increasing a hydraulic braking performance ratio using the information of the idle time is applied.

Since the method of estimating the idle time after parking using the current time information does not reflect the difference in the occurrence of brake moisture and corrosion according to an external environment (rainfall or snowfall) during actual driving, it is performed by simply increasing the hydraulic braking performance ratio considering only the idle time, there is a problem that the hydraulic braking performance ratio for removing moisture and corrosion of the brake is not accurate.

In addition, due to this problem, when the ratio of hydraulic braking to moisture or corrosion is actually high, hydraulic braking is performed unnecessarily, and thus, battery charging efficiency through regenerative braking may be lowered. Conversely, when the hydraulic braking performance ratio is low, there is a limit to reducing noise generation due to improper removal of moisture and corrosion.

The information included in this Background section is only for enhancement of understanding of the general background of the present disclosure and may not be taken as an acknowledgement or any form of suggestion that this information forms the prior art already known to a person skilled in the art.

### SUMMARY

An aspect of the disclosure is to estimate a brake damage level and determine a hydraulic braking performance ratio in consideration of an external environment when driving a vehicle.

Additional aspects of the disclosure will be set forth in part in the description which follows and, in part, will be obvious from the description, or may be learned by practice of the disclosure.

In accordance with an aspect of the disclosure, a vehicle includes: a brake; an vehicle sensor configured to obtain external environment information of the vehicle; a brake damage calculator configured to estimate a damage level of the brake based on the external environment information; a braking ratio calculator configured to calculate a regenerative braking and hydraulic braking performance ratio of the vehicle based on the estimated damage level of the brake; and a controller configured to control the vehicle to perform regenerative braking and hydraulic braking according to the calculated regenerative braking and hydraulic braking performance ratio.

The vehicle may further include a communicator configured to receive weather information.

The vehicle sensor may be configured to determine a rainfall or snowfall weight based on the weather information.

The vehicle sensor may be configured to identify a rainfall or snowfall exposure time of the vehicle, and to calculate an exposure amount of the vehicle due to the rainfall or snowfall based on the weight and the rainfall or snowfall exposure time of the vehicle.

The brake damage calculator may be configured to estimate the damage level of the brake based on the calculated rainfall or snowfall exposure amount and a driving or stopping time of the vehicle.

The brake damage calculator may be configured to estimate the damage level of the brake based on the calculated rainfall or snowfall exposure amount and an elapsed parking time after the vehicle has terminated driving.

The braking ratio calculator may be configured to calculate a hydraulic braking control amount based on the damage level of the brake.

The braking ratio calculator may be configured to identify a recovery state of the brake while performing a hydraulic braking control, and to calculate the regenerative braking and hydraulic braking performance ratio based on the recovery state of the brake.

The controller may be configured to calculate a regenerative braking control amount and a hydraulic braking control amount according to the regenerative braking and hydraulic braking performance ratio, to transmit information about the calculated regenerative braking control amount to a regenerative braking actuator, and to transmit information about the calculated hydraulic braking control amount to a hydraulic braking actuator.

The controller may be configured to control the regenerative braking actuator to perform the regenerative braking according to the regenerative braking control amount, and to control the hydraulic braking actuator to perform the hydraulic braking according to the hydraulic braking control amount.

In accordance with another aspect of the disclosure, a method of controlling a vehicle includes obtaining external environment information of a vehicle; estimating a damage level of the brake based on the external environment information of the vehicle; calculating a regenerative braking and hydraulic braking performance ratio based on the estimated damage level of the brake; and controlling the vehicle to perform regenerative braking and hydraulic braking according to the calculated regenerative braking and hydraulic braking performance ratio.

The method may further include receiving weather information.

The method may further include determining a rainfall or snowfall weight based on the weather information.

The method may further include identifying a rainfall or snowfall exposure time of the vehicle; and calculating an exposure amount of the vehicle due to the rainfall or snowfall based on the weight and the rainfall or snowfall exposure time of the vehicle.

The method may further include estimating the damage level of the brake based on the calculated rainfall or snowfall exposure amount and a driving or stopping time of the vehicle.

The method may further include estimating the damage level of the brake based on the calculated rainfall or snowfall exposure amount and an elapsed parking time after the vehicle has terminated driving.

The method may further include calculating a hydraulic braking control amount based on the damage level of the brake.

The method may further include identifying a recovery state of the brake while performing a hydraulic braking control; and calculating the regenerative braking and hydraulic braking performance ratio based on the recovery state of the brake.

The method may further include calculating a regenerative braking control amount and a hydraulic braking control amount according to the regenerative braking and hydraulic braking performance ratio; transmitting information about the calculated regenerative braking control amount to a regenerative braking actuator; and transmitting information about the calculated hydraulic braking control amount to a hydraulic braking actuator.

The method may further include controlling the regenerative braking actuator to perform the regenerative braking according to the regenerative braking control amount; and controlling the hydraulic braking actuator to perform the hydraulic braking according to the hydraulic braking control amount.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a vehicle according to an embodiment of the present disclosure.

FIG. 2 is a control block diagram of a vehicle according to an embodiment of the present disclosure.

FIG. 3 is a control block diagram of a vehicle according to an embodiment of the present disclosure.

FIG. 4 is a flowchart illustrating a method of controlling a vehicle according to an embodiment of the present disclosure.

FIG. 5 is a flowchart illustrating a control method of an vehicle sensor according to an embodiment of the present disclosure.

FIG. 6 is a flowchart of a control method of a damage calculator according to an embodiment of the present disclosure.

FIG. 7 is a flowchart illustrating a control method of a braking ratio calculator according to an embodiment of the present disclosure.

### DETAILED DESCRIPTION

Like reference numerals refer to like elements throughout the specification. Not all elements of the embodiments of the disclosure will be described, and the description of what are commonly known in the art or what overlap each other in the exemplary embodiments will be omitted. The terms as used throughout the specification, such as “˜part”, “˜module,” “˜member,” “˜block,” etc., may be implemented in software and/or hardware, and a plurality of “˜parts,” “˜modules,” “˜members,” or “˜blocks” may be implemented in a single element, or a single “˜part,” “˜module,” “˜member,” or “˜block” may include a plurality of elements.

It will be further understood that the term “connect” and its derivatives refer both to direct and indirect connection, and the indirect connection includes a connection over a wireless communication network.

The terms “include (or including)” and “comprise (or comprising)” are inclusive or open-ended and do not exclude additional, unrecited elements or method steps, unless otherwise mentioned. It will be further understood that the term “member” and its derivatives refer both to when a member is in contact with another member and when another member exists between the two members.

Further, when it is stated that a layer is “on” another layer or substrate, the layer may be directly on another layer or substrate or a third layer may be disposed therebetween.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are merely used for convenience of explanation, but not to limit an order of the steps. Thus, unless the context clearly dictates otherwise, the written order may be practiced otherwise.

Hereinafter, an operation principle and embodiments of the disclosure will be described with reference to accompanying drawings.

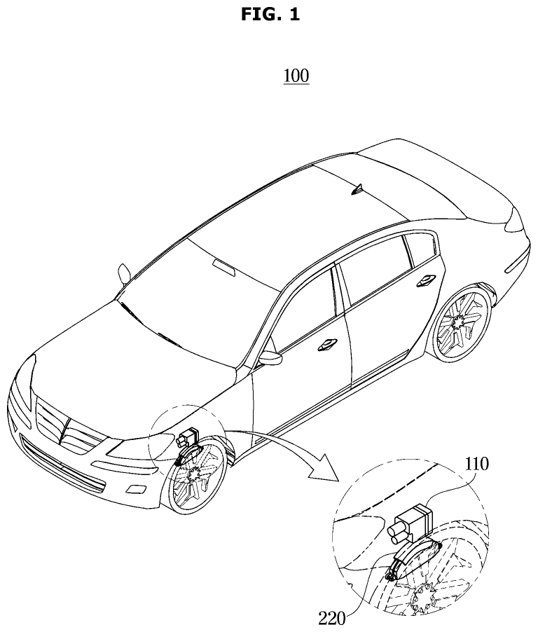

FIG. 1 is a view illustrating a vehicle according to an embodiment of the present disclosure.

Referring to FIG. 1, a vehicle 100 may include an actuator 110 and a brake 220.

The actuator 110 may be a hydraulic brake actuator.

Each of the calipers of the brake 220 may include, for example, a pair of brake pads provided on both sides of a brake disc. The pair of brake pads may be pressed toward the brake disc from both sides of the brake disc by hydraulic or mechanical pressure, for example, the actuator 110. Due to a friction between the brake pads and the brake disc, a rotation of wheels may be stopped.

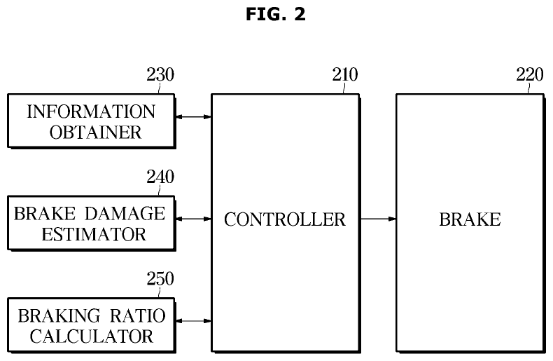

FIG. 2 is a control block diagram of a vehicle according to an embodiment of the present disclosure.

Referring to FIG. 2, the vehicle 100 may include the brake 220, an vehicle sensor 230 for obtaining external environment information of the vehicle 100 by an external environment, a brake damage calculator 240 for estimating a damage level of the brake 220 based on the external environment information of the vehicle 100, a braking ratio calculator 250 for calculating regenerative braking and hydraulic braking performance ratio based on the estimated damage level of the brake 220, and a controller 210 for controlling the vehicle 100 to perform regenerative braking and hydraulic braking according to the calculated regenerative braking and hydraulic braking performance ratio.

In the present disclosure, the vehicle sensor 230 may be a real-time monitor that can measure a temperature, coolant levels, oil pressure, emission levels, rain or snow drops, etc. Furthermore, the vehicle sensor 230 may include a visual or radar sensor, a Liar sensor, an oxygen sensor, a current sensor, a speed sensor, a humidity sensor, a timer, etc. The brake damage calculator 240 and the braking ratio calculator 250 may be a processor such as a CPU for performing operations (e.g., estimation and calculation) specified by the instructions in the program.

When the vehicle 100 is driving, the vehicle sensor 230 may identify a time period during which the vehicle 100 is exposed to the external environment such as rainfall or snowfall.

In this case, the rainfall or snowfall is described as the external environment, but it is not limited to the rainfall or snowfall.

In addition, the vehicle sensor 230 may determine a weight for the rainfall or snowfall based on weather information.

In more detail, the weight of the rainfall or snowfall is to prevent a case where the external environment information may be misrecognized due to sensor contamination of the vehicle 100, and may compare the external environment information obtained from a sensor of the vehicle 100 with the weather information obtained from a communicator of the vehicle 100. Based on the external environment information and the weather information, the weight may be determined on a rainfall or snowfall degree value obtained from the sensor of the vehicle 100.

An exposure amount of the vehicle 100 due to the rainfall or snowfall may be calculated by reflecting the identified rainfall or snowfall exposure time and the determined rainfall or snowfall weight.

The brake damage calculator 240 may estimate the damage level of the brake 220 based on the rainfall or snow exposure amount calculated by the vehicle sensor 230 and a driving or stopping time of the vehicle 100.

Here, the damage to the brake 220 may be damage due to moisture or corrosion of the brake disc or the brake pads, but is not limited thereto.

The brake damage calculator 240 may estimate the damage level of the brake 220 based on the calculated rainfall or snowfall exposure amount and an elapsed parking time after the vehicle 100 has terminated driving.

The braking ratio calculator 250 may calculate a hydraulic braking control amount according to the damage level of the brake 220, and calculate a performance ratio for performing the hydraulic braking and the regenerative braking based on the calculated hydraulic braking control amount.

The controller 210 may control the vehicle 100 to perform the hydraulic braking according to the calculated hydraulic braking control amount.

The controller 210 may identify a damage recovery state of the brake 220 while the vehicle 100 performs the hydraulic braking.

The braking ratio calculator 250 may recalculate the hydraulic braking control amount based on the identified recovery state of the brake 220, and may recalculate the performance ratio for performing the hydraulic braking and the regeneration braking based on the recalculated hydraulic braking control amount.

The controller 210 may be implemented with a memory storing an algorithm to control operation of the components in the vehicle 100 or data about a program that implements the algorithm, and a processor carrying out the aforementioned operation using the data stored in the memory. The memory and the processor may be implemented in separate chips. Alternatively, the memory and the processor may be implemented in a single chip. In addition, the vehicle sensor 230, the brake damage calculator 240, and the braking ratio 250 may be separate processors controlled by the controller 210, or may be embedded in the controller 210 as one control unit.

The memory may be implemented with at least one of a non-volatile memory device, such as cache, read only memory (ROM), programmable ROM (PROM), erasable programmable ROM (EPROM), electrically erasable programmable ROM (EEPROM), a volatile memory device, such as random access memory (RAM), or a storage medium, such as a hard disk drive (HDD) or a compact disk (CD) ROM, without being limited thereto. The memory may be a memory implemented with a chip separate from the aforementioned processor in relation to the controller 210, or may be implemented integrally with the processor in a single chip.

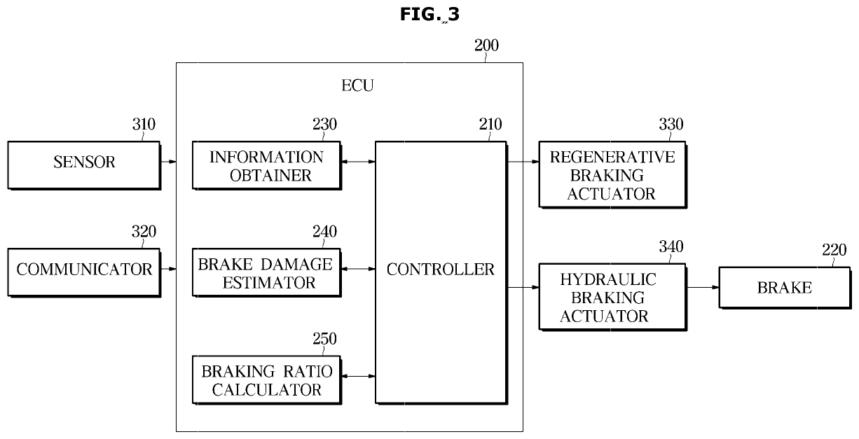

FIG. 3 is a control block diagram of a vehicle according to an embodiment of the present disclosure.

Referring to FIG. 3, an electronic control unit (ECU) 200 of the vehicle 100 may include the vehicle sensor 230 for obtaining external environment information of the vehicle 100 by the external environment, the brake damage calculator 240 for estimating the damage level of the brake 220 based on the external environment information of the vehicle 100, the braking ratio calculator 250 for calculating the regenerative braking and hydraulic braking performance ratio based on the estimated damage level of the brake 220, and the controller 210 for controlling the operation of the brake 220 according to the calculated regenerative braking and hydraulic braking performance ratio.

In addition, the vehicle 100 may include a sensor 310, a communicator 320, a regenerative braking actuator 330, a hydraulic braking actuator 340, and the brake 220. Although not illustrated, the vehicle 100 may include a GPS (Global Positioning System) receiver.

Here, the sensor 310 may include a rainwater detection sensor, a wiper control unit sensor, and a camera sensor. The sensor 310 and the vehicle sensor 230 may be integrated in one sensor unit.

The rainwater detection sensor may detect rainwater affecting the vehicle 100 from the outside of the vehicle 100, and provide information for estimating rainfall to the ECU 200.

When a driver operates a wiper, the wiper control unit sensor may provide information about an operating state of the wiper to the ECU 200.

For example, when the wiper is operating, the vehicle 100 may be determined that the vehicle 100 is exposed to rainfall or snowfall.

The camera sensor may analyze the weather information from image information capturing the external environment, and provide the analyzed weather information to the ECU 200.

The communicator 320 may receive the weather information from the outside and provide the received result to the ECU 200.

For example, the weather information received from the communicator 320 may include probability information of rainfall or snowfall.

The vehicle sensor 230 may use the weather information received from the communicator 320 to identify rainfall estimation information received from the sensor 310, information about the wiper operation state, and an accuracy of the analyzed weather information.

For example, in the weather information received from the communicator 320, when rainfall or snowfall is predicted, it is possible to increase reliability of the rainfall estimation information received from the sensor 310, the information about the wiper operation state, and the weather information analyzed from the image obtained through the camera sensor.

When rainfall or snowfall is not predicted, the reliability of the rainfall estimation information received from the sensor 310, the information about the wiper operation state, and the weather information analyzed from the image obtained through the camera sensor may not be reliable.

Using the information received from the sensor 310, it is possible to identify whether an exposure condition of the vehicle 100 is rainfall or snowfall, and accumulate the exposure time.

More particularly, a time when the vehicle 100 starts to be exposed to rainfall or snowfall while driving may be received from the GPS receiver, and a time when the vehicle 100 terminates driving and starts parking indoors may be received from the GPS receiver. The exposure time of the vehicle 100 may be accumulated by calculating a time between the time when the indoor parking is started and the time when the exposure to the rainfall or snowfall is started.

The exposure amount of the vehicle 100 due to the rainfall or snowfall may be calculated based on the accumulated exposure time.

The damage calculator 240 may identify time information for each section when the vehicle 100 is driving or temporarily stopped while driving, using the current time information received from the GPS receiver.

The damage calculator 240 may estimate the damage level of the brake 220 based on the exposure time for each section when the vehicle 100 is temporarily stopped while driving, using the rainfall or snowfall exposure amount of the vehicle 100 calculated by the vehicle sensor 230.

In addition, the damage level of the brake 220 may be estimated in consideration of a driving environment for a certain section before the vehicle 100 terminates.

In particular, it is possible to identify the driving environment for the certain section of the vehicle 100. When a large amount of braking force is used in the certain section before the termination of the vehicle 100, there is a possibility that the damage to the brake 220 due to the rainfall or snowfall has been recovered due to frequent braking. This is to reflect the damage level of the brake 220. In this case, at least one of a magnitude of the braking force or a period in which the braking force is applied may be reflected in estimating the damage level of the brake 220.

The braking ratio calculator 250 may calculate the hydraulic braking control amount required for each damage level by using the damage level of the brake 220 estimated by the damage calculator 240.

The braking ratio calculator 250 may estimate the damage recovery state of the brake 220 while the vehicle 100 performs the hydraulic braking according to the calculated hydraulic braking control amount.

The controller 210 may calculate the required hydraulic braking control amount again based on the damage recovery state of the brake 220 estimated by the braking ratio calculator 250.

For example, when the damage recovery state of the brake 220 is 30%, the hydraulic braking control amount corresponding to the remaining 70% for damage recovery of the brake 220 may be calculated.

Until the damage recovery of the brake 220 is completed, the hydraulic braking control amount corresponding to the required amount for completing the damage recovery of the brake 220 may be repeatedly calculated.

The braking ratio calculator 250 may calculate the hydraulic braking and regenerative braking performance ratio according to the recalculated hydraulic braking control amount.

The controller 210 may calculate the hydraulic braking control amount and the regenerative braking control amount according to the calculated performance ratio.

The controller 210 may transmit information about the calculated regenerative braking control amount to the regenerative braking actuator 330.

The controller 210 may transmit information about the calculated hydraulic braking control amount to the hydraulic braking actuator 340.

The controller 210 may control the hydraulic braking actuator 340 so that the vehicle 100 performs the hydraulic braking.

The brake 220 may be operated by the hydraulic braking actuator 340. As a result, damage to the brake 220 may be recovered. In addition, as the damage to the brake 220 is recovered, a creep noise phenomenon may be improved.

The controller 210 may control the regenerative braking actuator 350 so that the vehicle 100 performs the regenerative braking based on the regenerative braking control amount by the regenerative braking actuator 350.

The communicator 320 may include one or more components that enable communication with various external devices, for example, at least one of a short-range communication module, a wired communication module, and a wireless communication module.

The short-range communication module may include various short-range communication modules for transmitting and receiving signals within a short range over a wireless communication network, such as a Bluetooth module, an infrared communication module, a radio frequency identification (RFID) communication module, a wireless local access network (WLAN) communication module, a near field communication (NFC) module, a Zigbee communication module, etc.

The wired communication module may include not only one of the various wired communication modules, such as a controller area network (CAN) communication module, a local area network (LAN) module, a wide area network (WAN) module, or a value added network (VAN) module, but also one of various cable communication modules, such as a universal serial bus (USB), a high definition multimedia interface (HDMI), a digital visual interface (DVI), recommended standard (RS) 232, a power cable, or a plain old telephone service (POTS).

The wireless communication module may include a wireless fidelity (WiFi) module, a wireless broadband (WiBro) module, and/or any wireless communication module for supporting various wireless communication schemes, such as a global system for a mobile communication (GSM) module, a code division multiple access (CDMA) module, a wideband code division multiple access (WCDMA) module, a universal mobile telecommunications system (UMTS), a time division multiple access (TDMA) module, a long-term evolution (LTE) module, and the like.

The wireless communication module may include a wireless communication interface including an antenna and a transmitter for transmitting signals. In addition, the wireless communication module may further include a signal conversion module for modulating a digital control signal output from the controller 210 into an analog type wireless signal through the wireless communication interface under control of the controller 210.

The wireless communication module may include a wireless communication interface including an antenna and a receiver for receiving signals.

In addition, the wireless communication module may further include a signal conversion module for demodulating an analog wireless signal received through the wireless communication interface into a digital control signal.

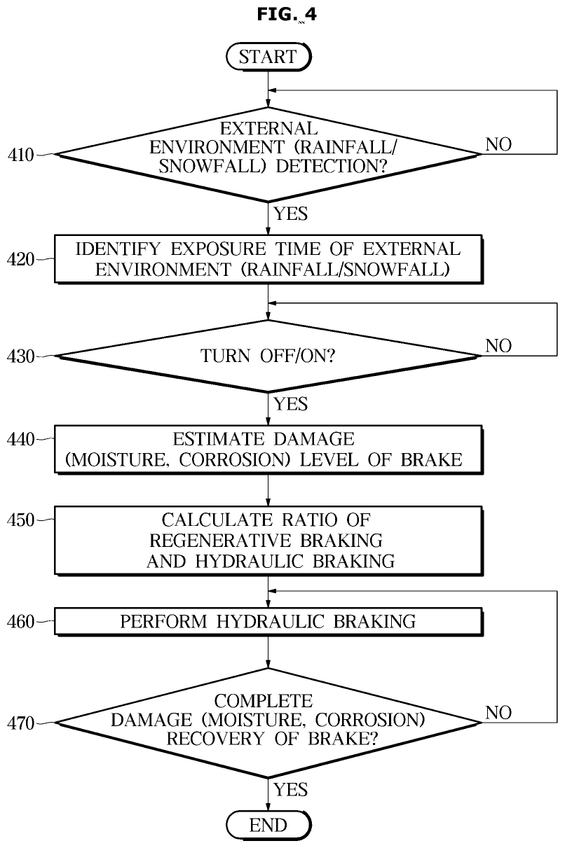

FIG. 4 is a flowchart illustrating a method of controlling a vehicle according to an embodiment of the present disclosure.

Referring to FIG. 4, a method of improving noise according to recovery of brake damage of the vehicle 100 will be described.

The vehicle 100 may detect rainfall or snowfall while driving (410).

When the vehicle 100 detects rainfall or snowfall while driving, the vehicle 100 may identify the time when the vehicle 100 is exposed to rainfall or snowfall, and accumulate the exposure time (420).

In more detail, by identifying the time when the vehicle 100 is exposed to rainfall or snowfall, the time when the vehicle 100 starts to be exposed to rainfall or snowfall while driving may be received from the GPS receiver, and the time when the vehicle 100 terminates driving and starts parking indoors may be received from the GPS receiver. The exposure time of the vehicle 100 may be accumulated by calculating the time between the time when the indoor parking is started and the time when the exposure to the rainfall or snowfall is started.

After the vehicle 100 is turned off, the vehicle 100 may identify whether the vehicle 100 is turned on again after a predetermined time (430).

Here, it may be determined that the vehicle 100 is turned off as the vehicle 100 is parked indoors that are not affected by the external environment.

After the vehicle 100 is turned off, if the vehicle 100 is not yet turned on, it may be identified repeatedly until the vehicle 100 is turned on again.

After the vehicle 100 is turned off and the vehicle 100 is turned on again after the predetermined time, the vehicle 100 may start driving and determine that the vehicle 100 has been exposed to rainfall or snowfall again.

The damage level of the brake 220 may be estimated based on the calculated rainfall or snowfall exposure amount of the vehicle 100 (440).

In more detail, a method of estimating the damage level of the brake 220 may include calculating the rainfall or snowfall exposure amount of the vehicle 100 by reflecting the rainfall or snowfall weight based on the weather information.

The damage level of the brake 220 may be estimated based on the rainfall or snowfall exposure amount of the vehicle 100 and a temporary stopping time during driving or driving of the vehicle 100.

The damage level of the brake 220 may be estimated based on the rainfall or snowfall exposure amount of the vehicle 100 and the elapsed parking time after the driving of the vehicle 100 is terminated.

Here, the damage to the brake 220 may be damage such as moisture or corrosion of the brake disc or the brake pads, but is not limited thereto.

The vehicle 100 may calculate the performance ratio of the regenerative braking and the hydraulic braking of the vehicle 100 based on the damage level of the brake 220 (450).

More particularly, the method of calculating the performance ratio of the regenerative braking and the hydraulic braking by the vehicle 100 may include calculating the hydraulic braking control amount required for each damage level by using the damage level of the brake 220.

According to the calculated hydraulic braking control amount, the hydraulic braking of the vehicle 100 may be performed (460).

In more detail, the information about the hydraulic braking control amount may be transmitted to the hydraulic braking actuator 340.

The vehicle 100 may control the hydraulic braking actuator 340 to perform the hydraulic braking.

As the hydraulic braking is performed, the damage to the brake 220 may be recovered by operating the brake 220.

The vehicle 100 may identify whether the damage to the brake 220 is recovered (470).

When the damage to the brake 220 is not recovered, the vehicle 100 may perform the hydraulic braking again according to the recovery state of the brake 220 (460).

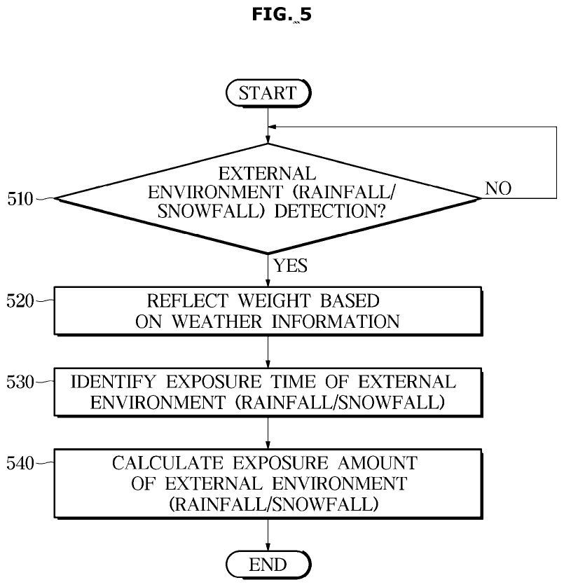

FIG. 5 is a flowchart illustrating a control method of an vehicle sensor according to an embodiment of the present disclosure.

Referring to FIG. 5, a method of improving noise according to brake damage recovery performed by the vehicle sensor 230 of the vehicle 100 will be described.

The vehicle 100 may detect rainfall or snowfall while driving (510).

In more detail, the vehicle 100 may detect rainfall or snowfall by detecting rainwater from the outside from the rainwater detection sensor.

In addition, when the driver operates the wiper, the vehicle 100 may detect rainfall or snowfall by receiving information about the operating state of the wiper from the wiper control unit sensor.

For example, when the wiper is operating, it may be determined that the vehicle 100 is exposed to rainfall or snowfall.

In addition, the vehicle 100 may detect rainfall or snowfall by analyzing the weather information from the image information capturing the external environment from the camera sensor.

In calculating the rainfall or snowfall exposure amount, the vehicle 100 may reflect the weight based on the weather information (520).

More particularly, the weight of the rainfall or snowfall is to prevent a case where the external environment information may be misrecognized due to the sensor contamination of the vehicle 100, and the external environment information obtained from the sensor of the vehicle 100 and the weather information obtained from the communicator of the vehicle 100 may be compared. Based on the external environment information and the weather information, the weight may be determined for the rainfall or snowfall degree value obtained from the sensor of the vehicle 100.

For example, when rainfall or snowfall is predicted based on the weather information received from the communicator 320, the weight may be reflected in the rainfall or snowfall degree value of the vehicle 100.

The vehicle 100 may identify the time when the vehicle 100 is exposed to rainfall or snowfall (530).

The vehicle 100 may accumulate the exposure time of the vehicle 100 and calculate the exposure amount of the vehicle 100 due to the rainfall or snowfall based on the accumulated exposure time (540).

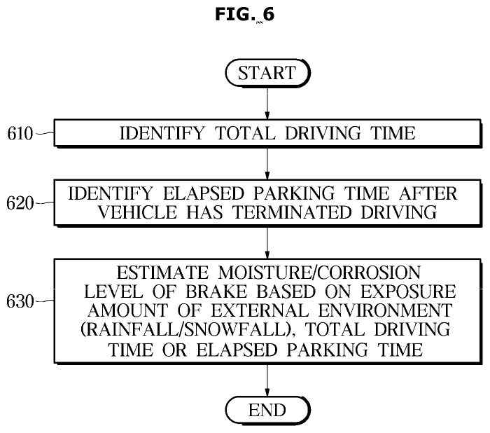

FIG. 6 is a flowchart of a control method of a damage calculator according to an embodiment of the present disclosure.

Referring to FIG. 6, a method of improving noise according to brake damage recovery performed by the damage calculator 240 of the vehicle 100 will be described.

The vehicle 100 may identify a total driving time of the vehicle 100 (610).

In more detail, the vehicle 100 may identify time information for each section when the vehicle 100 is driving or temporarily stopped while driving by using the current time information received from the GPS receiver.

The vehicle 100 may identify the elapsed parking time after the vehicle 100 has terminated driving (620).

The vehicle 100 may estimate the damage level of the brake 220 based on the calculated amount of rainfall or snowfall, and the exposure time for each section when the vehicle 100 is driving or temporarily stopped while driving (630).

Here, the damage to the brake 220 may be damage due to moisture or corrosion of the brake disc or the brake pads, but is not limited thereto.

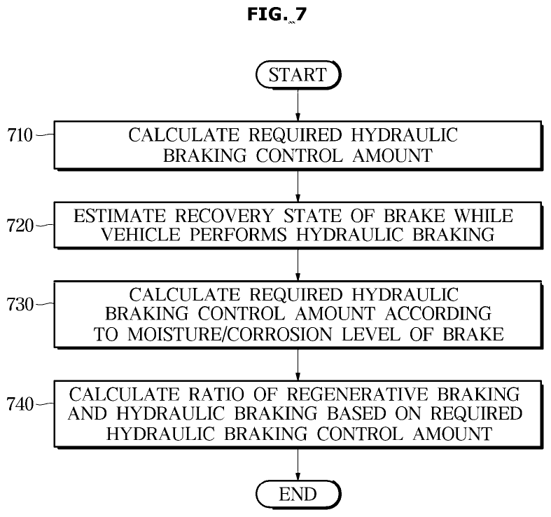

FIG. 7 is a flowchart illustrating a control method of a braking ratio calculator according to an embodiment of the present disclosure.

Referring to FIG. 7, a method of improving noise according to brake damage recovery performed by the braking ratio calculator 250 of the vehicle 100 will be described.

The vehicle 100 may calculate the hydraulic braking control amount (710).

In more detail, the vehicle 100 may calculate the hydraulic braking control amount required for each damage level based on the damage level of the brake 220.

The vehicle 100 may estimate the damage recovery state of the brake 220 while the vehicle 100 performs the hydraulic braking according to the calculated hydraulic braking control amount (720).

The vehicle 100 may calculate the required hydraulic braking control amount again according to the damage recovery state of the brake 220 (730).

Here, until the damage recovery of the brake 220 is completed, the hydraulic braking control amount corresponding to the required amount for completing the damage recovery of the brake 220 may be repeatedly calculated.

The vehicle 100 may calculate the hydraulic braking and regenerative braking performance ratio according to the calculated hydraulic braking control amount.

According to the embodiments of the disclosure, the vehicle has an advantage of reducing unnecessary hydraulic braking and effectively reducing fuel economy obtained by regenerative braking by determining a more accurate hydraulic braking ratio in consideration of the external environment when driving the vehicle.

In addition, by determining a more accurate hydraulic braking performance ratio, the disclosure may be effective in removing brake damage, and may effectively reduce the occurrence of noise due to brake damage.

The disclosed embodiments may be implemented in the form of a recording medium storing computer-executable instructions that are executable by a processor. The instructions may be stored in the form of a program code, and when executed by a processor, the instructions may generate a program module to perform operations of the disclosed embodiments. The recording medium may be implemented non-transitory as a computer-readable recording medium.

The non-transitory computer-readable recording medium may include all kinds of recording media storing commands that can be interpreted by a computer. For example, the non-transitory computer-readable recording medium may be, for example, ROM, RAM, a magnetic tape, a magnetic disc, flash memory, an optical data storage device, and the like.

Embodiments of the disclosure have thus far been described with reference to the accompanying drawings. It should be apparent to those of ordinary skill in the art that the disclosure may be practiced in other forms than the embodiments as described above without changing the technical idea or essential features of the disclosure. The above embodiments are only by way of example, and should not be interpreted in a limited sense.

What is claimed is:

1. A vehicle comprising:
a brake;
an vehicle sensor configured to obtain external environment information of the vehicle;
a brake damage calculator configured to estimate a damage level of the brake based on the external environment information;
a braking ratio calculator configured to calculate a regenerative braking and hydraulic braking performance ratio of the vehicle based on the estimated damage level of the brake; and
a controller configured to control the vehicle to perform regenerative braking and hydraulic braking according to the calculated regenerative braking and hydraulic braking performance ratio.

2. The vehicle according to claim 1, further comprising a communicator configured to receive weather information.

3. The vehicle according to claim 2, wherein the vehicle sensor is configured to determine a rainfall or snowfall weight based on the weather information.

4. The vehicle according to claim 3, wherein the vehicle sensor is configured to:
identify a rainfall or snowfall exposure time of the vehicle, and
calculate an exposure amount of the vehicle due to the rainfall or snowfall based on the weight and the rainfall or snowfall exposure time of the vehicle.

5. The vehicle according to claim 3, wherein the brake damage calculator is configured to estimate the damage level of the brake based on the calculated rainfall or snowfall exposure amount and a driving or stopping time of the vehicle.

6. The vehicle according to claim 3, wherein the brake damage calculator is configured to estimate the damage level of the brake based on the calculated rainfall or snowfall exposure amount and an elapsed parking time after the vehicle has terminated driving.

7. The vehicle according to claim 1, wherein the braking ratio calculator is configured to calculate a hydraulic braking control amount based on the damage level of the brake.

8. The vehicle according to claim 1, wherein the braking ratio calculator is configured to:
identify a recovery state of the brake while performing a hydraulic braking control, and
calculate the regenerative braking and hydraulic braking performance ratio based on the recovery state of the brake.

9. The vehicle according to claim 1, wherein the controller is configured to:
calculate a regenerative braking control amount and a hydraulic braking control amount according to the regenerative braking and hydraulic braking performance ratio,
transmit information about the calculated regenerative braking control amount to a regenerative braking actuator, and
transmit information about the calculated hydraulic braking control amount to a hydraulic braking actuator.

10. The vehicle according to claim 9, wherein the controller is configured to:
control the regenerative braking actuator to perform the regenerative braking according to the regenerative braking control amount, and
control the hydraulic braking actuator to perform the hydraulic braking according to the hydraulic braking control amount.

11. A method of controlling a vehicle comprising:
obtaining external environment information of the vehicle;
estimating a damage level of the brake based on the external environment information of the vehicle;
calculating a regenerative braking and hydraulic braking performance ratio based on the estimated damage level of the brake; and
controlling the vehicle to perform regenerative braking and hydraulic braking according to the calculated regenerative braking and hydraulic braking performance ratio.

12. The method according to claim 11, further comprising receiving weather information.

13. The method according to claim 12, further comprising determining a rainfall or snowfall weight based on the weather information.

14. The method according to claim 12, further comprising:
identifying a rainfall or snowfall exposure time of the vehicle; and
calculating an exposure amount of the vehicle due to the rainfall or snowfall based on the weight and the rainfall or snowfall exposure time of the vehicle.

15. The method according to claim 14, further comprising estimating the damage level of the brake based on the calculated rainfall or snowfall exposure amount and a driving or stopping time of the vehicle.

16. The method according to claim 14, further comprising estimating the damage level of the brake based on the calculated rainfall or snowfall exposure amount and an elapsed parking time after the vehicle has terminated driving.

17. The method according to claim 11, further comprising calculating a hydraulic braking control amount based on the damage level of the brake.

18. The method according to claim 11, further comprising:
identifying a recovery state of the brake while performing a hydraulic braking control; and
calculating the regenerative braking and hydraulic braking performance ratio based on the recovery state of the brake.

19. The method according to claim 11, further comprising:
calculating a regenerative braking control amount and a hydraulic braking control amount according to the regenerative braking and hydraulic braking performance ratio;
transmitting information about the calculated regenerative braking control amount to a regenerative braking actuator; and
transmitting information about the calculated hydraulic braking control amount to a hydraulic braking actuator.

20. The method according to claim 18, further comprising:
controlling the regenerative braking actuator to perform the regenerative braking according to the regenerative braking control amount; and
controlling the hydraulic braking actuator to perform the hydraulic braking according to the hydraulic braking control amount.
